(19) United States
(12) Patent Application Publication
(10) Pub. No.: US 2014/0302135 A1
(43) Pub. Date: Oct. 9, 2014

(54) Microencapsulation as a strategy for implementation and environmental safe-guarding of a paratransgenic approach to control of vector-borne diseases

(71) Applicants: Ravi Durvasula, Albuquerque, NM (US); Adam Forshaw, Albuquerque, NM (US)

(72) Inventors: Ravi Durvasula, Albuquerque, NM (US); Adam Forshaw, Albuquerque, NM (US)

(73) Assignee: STC.UNM, Albuquerque, NM (US)

(21) Appl. No.: 14/303,195

(22) Filed: Jun. 12, 2014

Related U.S. Application Data
(63) Continuation-in-part of application No. PCT/US12/62734, filed on Oct. 31, 2012.
(60) Provisional application No. 61/569,723, filed on Dec. 12, 2011.

(51) Int. Cl. A01N 25/26

(52) U.S. Cl. CPC A01N 25/26
USPC 424/456; 424/451; 424/463

(57) ABSTRACT

A microparticle comprising a pesticidal agent encapsulated within a polymer coating, the polymer coating comprising an oil-soluble dye wherein the oil-soluble dye and the polymer coating increases the pesticidal agent's ability to withstand UV radiation, a method of manufacturing the microparticle and a method of using the microparticle to control pests

### CROSS-REFERENCE TO RELATED APPLICATIONS

This application is a Continuation-in-Part application of International Application No. PCT/US12/062734, entitled “Microencapsulation as a Strategy for Implementation and Environmental Safe-guarding of a Paratransgenic Approach to Control of Vector-Borne Diseases”, filed Oct. 31, 2012, which claims priority to and the benefit of U.S. Provisional Patent Application Ser. No. 61/569,723, entitled “Microencapsulation as a Strategy for Implementation and Environmental Safe-guarding of a Paratransgenic Approach to Control of Vector-Borne Diseases”, filed Dec. 12, 2011, and the specifications and claims of which are incorporated herein by reference.

### BACKGROUND

Insect pests account for tremendous agricultural burden throughout the world, resulting in billions of dollars spent on insecticides and hundreds of billions of dollars due to crop loss and extra labor necessary to treat pest outbreaks. (1, 2) Traditionally, arthropod control has been accomplished with intensive pesticide use. (3) The U.S. Environmental Protection Agency (EPA) estimates that nearly 1.2 billion dollars (US$) is spent annually in the United States alone on pesticides and herbicides at over 1 million grower's sites (farms, plantations, storage facilities etc). (4) Unfortunately, the widespread and unchecked use of chemical pesticides has led to increased resistance as well as contamination and bioamplification of some of these toxins. (4, 5) Compounds such as DDT and the neurotoxin dieldrin are now prohibited from use in the United States because of environmental degradation and adverse impacts on human and animal health.

Currently the EPA, WHO and World Food Bank prioritize insect control campaigns that utilize integrated control strategies, including biological and sociological methods. (6) The control of pest arthropods via biologically-derived agents such as insecticidal bacteria, parasitic insects, entomopathogenic nematodes and entomopathogenic fungi offers attractive and environmentally acceptable alternatives to chemical pesticides. (7) Entomopathogenic fungi, such as Metarhizium and Beauvaria sp., are naturally occurring soil-dwellers that have demonstrated pathogenicity towards target agricultural pests. Metarhizium anisopliae (var acridium) has been investigated for control of ticks (8, 9), tobacco hornworm (10), termites (11, 12) and for biocontrol of desert locusts, Schistocerca gregaria and Locusta migratoria in northern Africa. (5, 6, 13-15) Entomopathogenic fungi offer several advantages over chemical pesticides:
1) Fungal spores are obtained from natural habitats of pests and are usually not considered an “invasive foreign species”
2) Many fungal species are pathogenic to a specific pest with minimal lethality to cohabiting regional insects (5, 16, 17)
3) The manufacturing (culturing) of fungal agents is inexpensive, thereby offering very high profit margins in the pest control industry
4) There are no residual chemical effects or bioamplification
5) There is minimal regulation governing the release of such bio-pesticides, partly due to their recent emergence and partly due to the “organic” nature of the control element (18, 19)

Commercially, it is estimated that the current global market for organic biopesticides is roughly $594 million representing roughly 2.5% of global pesticide market. (15) This number is estimated to reach $1.2 billion by the year 2015. (20)

Commercial formulations of one such fungus, M. anisopliae, are available from the LUBILOSA initiative, a multi-country decade-long endeavor to identify fungal species for locust control in northern and western Africa. (19) Unfortunately, during broad-scale field implementation several challenges arise. Fungal conidia are rapidly inactivated by (1) ultraviolet radiation (UVR) (21, 22) (2) extreme temperatures and (3) excess humidity or aridity (23), thus reaching peak effectiveness only in a narrow range of habitats and temperatures. Given the harsh climatic conditions that characterize many agricultural regions of the world, novel technologies directed at improving field performance of these bio-pesticides would be commercially viable and would greatly enhance global food security.

An excellent example of field-based control with entomopathogenic fungi involves the desert locust, Schistocerca gregaria. This pest ravages crops from Morocco to India and results in billions of dollars of agricultural losses. Related locust strains in China and North America pose equal threats to global agriculture. In northern Africa alone, the problem of desert locust control necessitates nearly $10 million dollars annual expenditure from governments and NGO's for chemical spray campaigns. (5) However, in the event of insufficient spraying, desert locust swarms undergo a physical metamorphosis from “solitary” to “gregarious” forms, resulting in large swarms forming plagues. This was the case in 2003-2005 in Morocco, Tunisia, Syria, Senegal, Mali, Niger, Egypt, Jordan and Israel. Such plagues result in over $300 million direct cost for emergency spray campaigns, and over $2 billion in indirect cost from crop loss and man-hours invested. (5, 24) Efforts to treat desert locust breeding grounds with fungal insecticides are confounded by heat, aridity and solar UVB irradiation. (7, 21, 22) Various formulations have been used to enhance survival of fungal spores in the environment. Oil-based strategies have been reported to increase conidial viability in sunny, arid conditions (7, 25) as well as induce slightly higher mortality in locust populations; however success has been marginal (O-to-21% viability at one day, after 6 h of simulated solar-UV exposure). (25) Sunscreens added to oil formulations also protect conidia when exposed to UVR, however again with marginal success, (4-34% survival after as little as 1 hr. of UVB exposure utilizing SPF 50 sunscreens). (7, 21) Novel and inexpensive methods to protect and enhance conidia and other organic biopesticides are required.

### SUMMARY

Novel particular-based pesticides formed from pesticidal agents encapsulated in one or more coatings wherein the coating enhances the pesticidal agents ability to control a pest population, and methods for making and controlling pest populations with the same. In various embodiments the pesticidal agent may be a biopesticide and the coating may impart stability, protection from UV radiation and/or other environmental conditions, enhance the attractiveness of the pesticide to the pest, and/or serve to separate two different biologically incompatible pesticides within a mixture.

One embodiment of the present invention is a microparticle having a pesticidal agent (for example a bio-pesticide) encapsulated within a polymer coating. The polymer coating may include an oil-soluble dye. The oil-soluble dye and the polymer coating can help to increase the pesticidal agent's ability to withstand UV radiation. The oil-soluble dye is within a matrix of the polymer coating and the oil-soluble dye will increase the stability of the pesticidal agent in the pest's environment. In another embodiment the polymer coating encapsulates more than one type of pesticidal agent. In another embodiment, the polymer coating enables the pesticidal agent to be located in proximity to a pesticidal agent with which it is biologically incompatible. The polymer coating of the microparticle may be formed from a polymer selected from one or more of the following: alginate, gelatin, methylcellulose, ethylcellulose, chiton/dextran, Whey protein or polymethylmethacrylate but not limited thereto. In a particular embodiment the polymer coating is formed from alginate. The characteristics of the polymer are tunable to have a defined porosity, a defined diffusion rate of matter past the polymer coating and into the environment and a defined degradation rate. The polymer coatings may further include a characteristic that increases the attractiveness of the microparticle to the pest. In one embodiment the polymer coating prevents exposure of the pesticidal agent to the environment prior to ingestion by the pest. The polymer coating is degraded by the environmental conditions encountered within the pest's digestion tract. Further still, a secondary coating may be configured to further enhance the pesticidal agent's ability to control a pest population. The oil-soluble dye may be India ink, for example, and/or may be selected from one or more of the following: iron oxide, carbon, logwood, cinnabar, Cadmium Red, Napthol pigments, disazodiarylide, disazopyrazolone, Cadmium Yellow, curcumine, Chrome Yellow, chromium oxide, malachite, ferrocyanides, ochre, umber, Sweedish Red, lead chromate, Azure Blue, Cobalt Blue, Prussian Blue, Manganese Violet, quinacridone, lead carbonate, titanium dioxide, barium sulfate, zinc oxide, Carbon Black, Ivory Black, Vine Black, Lamp Black, and Titanium Black.

In another embodiment, a particle-based pesticide comprises a plurality of microparticles, wherein each microparticle is formed from a microencapsulated pesticidal agent. For example, the microparticle comprises a pesticidal agent such as a bio-pesticide microencapsulated within a coating configured to enhance the pesticidal agents ability to control a pest population. Further, the particle-based pesticide may include at least two populations of microparticles, wherein the populations differ from each other with respect to the pesticidal agent. For example the two different populations may be biologically incompatible with each other and/or may differ from each other with respect to the coating used to encapsulate the different pesticidal agents.

In yet another embodiment, a method of controlling a pest population includes exposing the pest population to a particle-based pesticide, wherein the particle-based pesticide comprises a plurality of microparticles.

In a further embodiment a method of manufacturing a pesticide includes encapsulating a pesticidal agent within a polymer coating (for example alginate) configured with an oil-soluble dye to enhance the pesticidal agents ability to control a pest population. For example, the step of encapsulating comprises extruding droplets comprising the pesticidal agent, oil-soluble dye and the polymer into a cross-linking or hardening solution to form particles. Further, the method may include surrounding the polymer coating of the particles with a secondary coating configured to further enhance the pesticidal agent's ability to control the pest population. Additionally, the method may include selecting the pesticidal agent based on a specific pest population against which the pesticide is to be used and/or selecting the materials to use to form the coating based on a specific pest population against which the pesticide is to be used.

### BRIEF DESCRIPTION OF THE DRAWINGS

FIG. 1 is a schematic illustration of a microencapsulated pesticide according to an embodiment of the present disclosure.

FIG. 2 is a flow chart showing an exemplary general method for forming the microencapsulated pesticide according to an embodiment of the present disclosure.

FIG. 3 is a schematic illustration of exemplary apparatus for making a microencapsulated pesticide according to an embodiment of the present disclosure.

FIG. 4 is a scanning electron micrograph of microencapsulated Pantoea agglomerans.

FIG. 5 is a graph showing the microparticle size distribution of microcapusles produced via atomization of alginates into crosslinking solution.

FIG. 6 is a graph showing P. agglomerans diffusion from microbeads over time.

FIG. 7 is a graph showing P. agglomerans survival after UVC treatment in alginate-carbon particles.

FIG. 8 is a graph showing UVC exposure of bio-encapsulated M. anisopliae demonstrating that alginate-encapsulated fungi are viable significantly longer than conventional oil emulsion or water/Tween formulations.

### DETAILED DESCRIPTION

According to an embodiment the present disclosure provides novel pesticides and methods for making the same. In general, the present disclosure provides a particulate-based pesticide wherein the population of particles that make up the pesticide comprises a plurality of microencapsulated pesticidal agents. According to one embodiment, one or more of the microencapsulated pesticidal agents is a genetically modified or unmodified biologically-based microorganism that is effective as a pesticide encapsulated within a coating that imparts a variety of characteristics to improve or enhance the ability of and/or the opportunity for the microorganism to act as a pesticide.

For the purposes of the present disclosure, an agricultural “pest” is an animal, insect, or plant that is detrimental to human concerns. These concerns may be health, environmentally, or economically based. For example, a pest may eat or otherwise destroy crops or act as a vector for a disease that negatively impacts crops or other plant-life, animals, or humans. Examples of pests include, but are not limited to, locusts, caterpillars, termites, sharpshooters, ants, beetles, flies, bollworm, borers, other insect larvae, etc. However, it will be understood that what is considered a pest in one context may not be considered a pest in another context. For example, an insect that eats a particular crop may be considered a pest in a location where and when that crop is cultivated, but may not be considered a pest, and may in fact contribute positively to the environment, where and when that particular crop is not being cultivated. Accordingly, a particular animal, insect, or plant is considered to be a pest when it has been identified as such in a particular context.

As used herein, the term “target,” when used as a noun, is used to identify the animal, plant, human, or other entity that is harmed by the presence of the pest and that such harm may be direct (i.e., a pest eating a particular crop) or indirect (i.e., a pest acting as a vector to transmit diseases or other pathogens).

As used herein, the term “pesticidal agent” is any natural or non-natural (i.e., human made or modified) chemical or biological agent that is able to control a pest population. Controlling a pest population typically involves affecting the pest population in such a way that the negative impact of the pest population is reduced or eliminated. Examples of ways in which a pest population is controlled include, but are not necessarily limited to, directly or indirectly killing or sterilizing pests, making the environment or target of the pest inhospitable or unattractive to the pest, and/or reducing or eliminating the ability of the pest to act as a vector for a disease.

Traditional chemical pesticides typically kill and/or sterilize pests (and non-pests), usually by presenting toxic agents to the pest. Accordingly, the effect of the chemical pesticide is often indiscriminate, impacting both pests and non-pests alike. Alternatively, a chemical pesticide may act to make the environmental conditions no longer suitable for or desirable to the pest population, for example by altering or masking a particular smell, color, or other indicator that attracts the pest to the target.

Biological or “bio-” pesticides are typically naturally occurring or biologically altered organisms that either directly or indirectly kill, harm, or sterilize pests, reduce or eliminate the pests' ability to act as a disease vector, or act to alter the target or the surrounding environmental conditions to make them no longer suitable for or desirable to the pest population. Because bio-pesticides frequently rely on a direct and specific biological interaction between the pest and the bio-pesticide, bio-pesticides can often be selected and/or designed to impact only a particular pest or category of pests.

Unless otherwise specified the terms “pesticide” or “pesticidal agents” are intended to encompass both chemical pesticides and bio-pesticides.

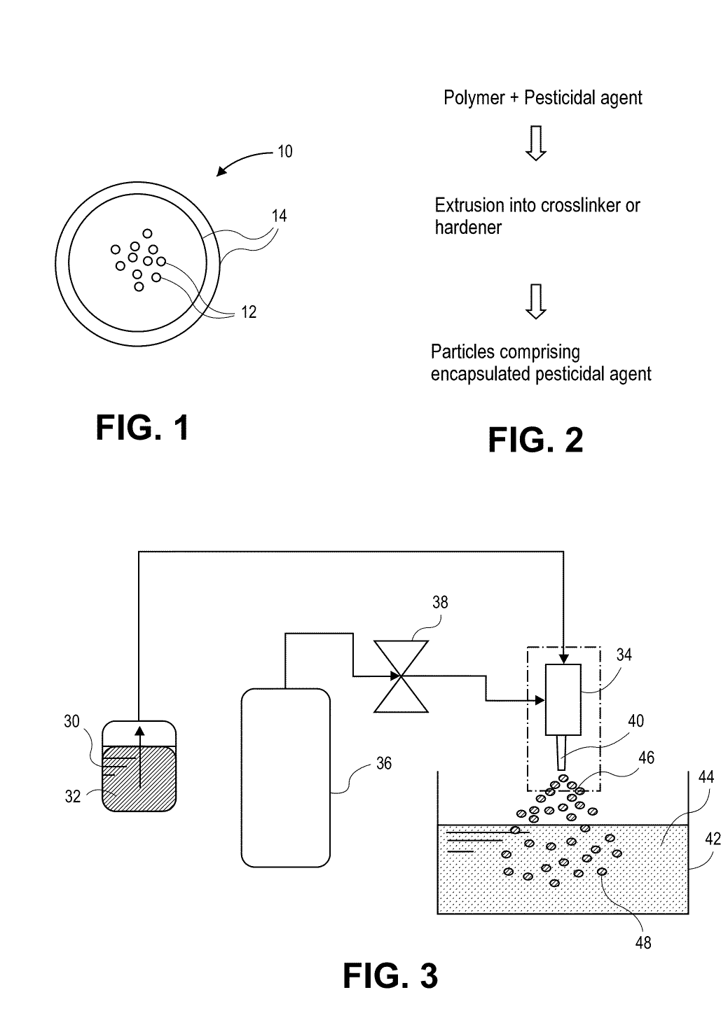

Turning to FIG. 1, an exemplary pesticide particle 10 is shown. One or more pesticidal agents 12 are encapsulated in one or more porous coatings 14, which may be formed, for example, in part, or entirely, from a polymer-based hydrogel with or without incorporation of aqueous or non-aqueous soluble materials (oil emulsions, attractants, micro/nanoparticulates, etc.).

According to various embodiments, the particular pesticidal agent or agents that are encapsulated can vary depending on specific needs and/or desires and may include one or more chemical or biological pesticides. Typically, however, only pesticidal agents that are known not to negatively affect each other when located proximate to each other would be encapsulated together.

According to some embodiments, the pesticidal agent is a bio-pesticide. Examples of known bio-pesticides include a wide variety of engineered and non-engineered bacteria, fungi, nematode eggs and the like. As specific examples, genetically modified symbiants of the bacteria Rhodococcus rhodnii as well as the fungus Beuaveria bassiana have been used successfully to control populations of the Triatomide “kissing” bug (Rhodinus prolixus), which is a known vector for the Trypanosoma cruzi pathogen responsible for the parasitic infection known as Chagas disease (See e.g., Dotson et al., Infect Genet Evol. 2003 July;3(s): 103-9, which is hereby incorporated by reference). Genetically modified forms of Bacillus subtilis have been used successfully to control populations of the Phylebotamine sand fly (P. argentipes), which is a known vector for the Leishmania infantum and Leishmania major vectors, which are responsible for both visceral and cutaneous leishmaniasis. Similarly, genetically modified forms of members of the Gram-negative bacteria Pantoea have been used successfully as a biopesticide to control Xylella diaseases, which are known to be carried by the Glassy-winged Sharpshooter (Homalodisca).

Those of skill in the art will be familiar with a wide variety of chemically and biologically-based pesticides which are suitable for use with the presently described inventions. Accordingly, it will be understood that nearly infinite numbers and combinations of pesticidal agents may be selected to be encapsulated to produce the pesticides described herein. Furthermore, it will be understood that other non-biological materials may also be incorporated, such as, but not necessarily limited to, chemical attractants, ultraviolet stabilizers and impermeable dyes.

The material or materials used to form the coating may be selected to impart specific characteristics such as stability and/or protection against various environmental factors, controlled-release rates, and attractiveness to specific pest populations. According to various embodiments, the coatings are typically insoluble in aqueous solutions and stable over a range of pH and in various media. In addition, the coating(s) may be designed to provide protection against conditions that are expected to be encountered by the pesticide, such as UV radiation, acid rain, dehydration, or other environmental or chemical conditions. Furthermore, according to some embodiments, it may be desirable to select a coating that enables or provides for a particular desired release rate of the pesticidal agent into the surrounding environment. Alternatively or additionally, the coatings may be selected to provide the microparticles with characteristics that increase their attractiveness to targeted pest populations. These desirability-based characteristics may include such things as, for example, color, smell, taste, texture, etc.

Non-limiting examples of suitable polymers that can be used include alginates, gelatin, cellulose, whey protein, chitosan/dextran, polymethylmethacrylate (PMMA), and carboxymethylcellulose. Alginate is commercially available as sodium alginate salt and may be useful in targeting insects such as grasshoppers, katydids, termites, ants, corn borers, fruit borers, caterpillars, and other chewing insects or soil chewing larva. Cellulose may be useful in targeting such insects as grasshoppers, borers, caterpillars and termites. Whey protein may be useful in targeting blood-feeding insects that may or may not harbor protein-metabolizing enzymes (kinases, amino transferases, etc.) in their guts. Chitosan/dextran and carboxymethylcellulose may be particularly useful in targeting termites and ants.

Additional materials such as chemical stabilizers or dyes may be included in the coating to impart additional characteristics. Non-limiting examples of chemical stabilizers that may be desirable to include are Gum Arabic, Guar Gum, Kappa carrageenan (K-carrageenan), Locus bean gum, Xanthem gum, and the like. In general, such chemical stabilizers are typically incorporated at between 0.1 and 10% (w/v) concentration. Gum Arabic (gum acacia) imparts high moisture retention and may be particularly useful in dry climates where one is likely to encounter desert locust, termites, etc. Gum Arabic is typically incorporated at between 0.1 and 5% (w/v) concentration. Guar gum also increases moisture retention and is typically incorporated at between 3 and 10% (w/v) concentration. K-carrageenan forms gels with potassium ions as well as locust bean gum and can impart significant gel stability as well as moisture retention. K-carrageenan is typically incorporated at between 1 and 10% (w/v) concentration. Locust bean gum forms more liquid emulsions and gels that are pliable and “chewy.” Locust bean gum can be added to K-carrageenan to form ridged, brittle gels. Locust bean gum is typically incorporated at between 0.1 and 5% (w/v) concentration. Xanthem gum can be used to increase the visco-elasticity of polymer solutions for ease in extrusion. Xanthem gum is typically incorporated at a between 0.1 and 5% (w/v) concentration.

Non-limiting examples of chemical dyes that can impart UV stability include dyes and/or pigments which may be water soluble or oil soluble. In a preferred embodiment one or more of the following may used as the dye or pigment,: India ink, carbonaceous micro/nanoparticles (graphite, charcoal dust), zinc oxide, and titanium dioxide. India Inks are typically incorporated at a concentration of 0.5-5% v/v solution. India Inks are available in a wide variety of colors. Yellow, brown, red, black, and purple have proven to be effective in providing protection against UV radiation, but it is believed that white and other colors should work as well. Insects are naturally attracted to yellow and white colors, so these (or other) colors may be selected to increase the attractiveness of the bio-pesticide to the target insect. Carbonaceous micro/nanoparticulates can be added at concentrations of 0.1-10% w/v and are chemically inert additives which block UV. Zinc oxide and titanium dioxide are both commonly found in sunblocks and are typically incorporated in concentrations of 1-10% w/v and 1-3% w/v, respectively.

In one embodiment of the present invention a water-soluble dye or pigment is utilized in the microparticle to protect the biopesticide from UV radiation. However, water-soluble chemical dyes may leach from the microparticle when delivered into an aqueous environment before the biopesticide has been delivered to the pest. If this occurs, the dye or pigment effectiveness as a UV protectantof the biopesticide is decreased or eliminated. In a preferred embodiment, an oil-soluble dye is particularly suitable in certain applications where the possibility of leaching may arise. An oil is defined as an organic or hydrocarbon solvent used for solvating a pigment or dye. Non-limiting examples of oils include hydrocarbons like pentane, hexane, octane, pentene, hexene, and octene; aromatics (or derivatives thereof) like benzene, toluene, xylene, and analine; oxygenated solvents and alcohols like methanol, ethanol, isopropanol, n-butyl alcohol, n-propyl alcohol, ethyl acetate, n-butyl acetate, n-propyl acetate, isopropyl acetate, acetone, cyclohexanone, methylsulfoxide, and dimethylsulfoxide; and organic cooking oils like canola oil, olive oil, coconut oil, cottonseed oil, palm oil, peanut oil, rapeseed oil, safflower oil, sesame oil, soybean oil, and sunflower oil. Non-limiting examples of suitable pigments and dyes include India ink pigments, (i.e., iron oxide, carbon, logwood), cinnabar, Cadmium Red, Napthol pigments, disazodiarylide, disazopyrazolone, Cadmium Yellow, curcumine, Chrome Yellow, chromium oxide, malachite, ferrocyanides, ochre, umber, Sweedish Red, lead chromate, Azure Blue, Cobalt Blue, Prussian Blue, Manganese Violet, quinacridone, lead carbonate, titanium dioxide, barium sulfate, zinc oxide, Carbon Black, Ivory Black, Vine Black, Lamp Black, and Titanium Black; other organically-soluble pigments like Methyl Violate 2b, Auamine O, Ehtyl Violet, Rhodamine B, Rhodamine 6G, Rhodamine 101, Malachite Green, Victoria Blue, Magenta, Bismark Brown, Azo Yellows (Yellow 2, 7, 12, 15, and 56), and Anthraquinone Red (Red 1, 4, 23, 24, 25); and organically derived pigments like those derived from soy oil, safflower, linseed, and canola.

In a particular example, India ink-dyed alginate gels have shown significant attenuation of UV transmission in gels with greater than 0.1% (v/v) India ink at similar thickness to a control. With each increase in ink concentration UV transmission is significantly attenuated. At 1.0% ink (v/v) UV transmission is nearly halved in all thicknesses. At greater than 5% ink (v/v) UV transmission is nearly extinguished in even 250 um thicknesses. No significant difference in UV transmission based on ink color selection was found (p=0.369).

Because of the increased UV protection created by India ink-dyed alginate gels, the survival rate of the encapsulated biopesticide is increased. In a representative experiment, the CFU count of P. agglomerans in un-dyed alginate beads decreased from a mean of 3.68×10̂6 CFUs at T=0 to 0 CFU's at T=300 min, while bacteria in 1% and 5% (v/v) India-ink gels showed little-to-no decrease in CFUs: 2.17×10̂6 CFUs @ T=0 to 2.22×10̂6 CFUs @ T=300. Alginate-encapsulated P. agglomerans and B. subtilis were exposed to high-intensity sterilizing radiation for 300 minutes. In hydrated “wet” alginate beads, the incorporation of India Ink in 0.1%, 1% and 5% (v/v) concentrations significantly protected encapsulated bacteria from UV sterilization over alginate alone (p<0.0028) and 1% and 5% gels protected significantly better than 0.1% gels (p<0.001). There was no significant difference between 1% and 5% gels in UV protection (p=0.21). In desiccated “dry” alginate beads, there was no significant difference between bacterial survival in any treatments (P=0.69). Highly similar findings occurred for alginate-encapsulated B. subtilis (results not presented).

In another representative experiment, M. anisopliae strain 324 spores were exposed to high-intensity UVC in 3 mm thick solutions of 20% oil-water (v/v) emulsion to represent commonly used applications methods,4 crosslinked alginate gels with and without the inclusion of 1.0% India Ink and a 2% Tween-80 emulsion which was used as a control. Spores in 10% Tween-80 emulsion underwent the most rapid sterilization over the course of UV exposure followed by spores in 20% oil emulsion. Spores encapsulated in sodium alginate lasted roughly 2× longer under UVC exposure before being fully sterilized, while spores encapsulated in 1% India Ink alginates showed an initial decline after the preliminary 5 min UVC exposure and then remained stable over the course of the experiment. Spores encapsulated in varying concentrations of India Ink demonstrated similar sterilization characteristics as encapsulated bacteria. Spores encapsulated in 1% and 5% India Ink demonstrated little decline over exposure interval, while those in 0.1% showed a slow-sustained decline. Both 1 & 5% India Ink-containing alginates significantly protected encapsulated spores when compared with 0 & 0.1% alginates after 5 min UVC exposure (p<0.001).

Controlled release rates may be obtained by modifying the polymer-based coating to include suitable mechanical or chemical release mechanisms. These release mechanisms may be activated by a variety of triggers including environmental factors such as pH, temperature, chemicals, or exposure to other environmental conditions. Release may be effected via diffusion, active transport, or other mechanism. According to some embodiments the polymer-based coating may be designed to biodegrade over a period of time or in response to certain biological, chemical, or environmental conditions. For example, a particular polymer-based coating may be designed to biodegrade or activate some other release mechanism upon encountering the environmental conditions that exist inside the gut or digestive tract of a particular insect.

Various colorizing agents can be incorporated via organic dyes (or India ink) or by physical materials including, but not necessarily limited to, microparticulates of iridescent plastics, carbonaceous dust, or graphite to block UV radiation. Examples of known insect attractants include: Octenol, egg albumin, sucrose, eugenol, naphthalene, benzene, and frontalin. Other examples are provided in Beroza and Green “Synthetic Chemicals as Insect Attractants” New Approaches to Pest Control and Eradication. Jan. 1, 1963, 11-30, which is hereby incorporated by reference.

Alternatively or additionally, the presence of the coatings can be used to provide mixtures of pesticidal agents that would normally not be stored together. For example, pesticidal agents that are incompatible (i.e., one agent is toxic to the other agent or one agent would deactivate or otherwise negatively affect the other) could each be coated separately and the resulting particles could then be mixed together to produce a mixed pesticide product that provides the benefits of both.

According to another embodiment, the present disclosure also provides methods and apparatus for producing the particulate-based pesticides described herein. According to one general method shown in FIG. 2, a mixture containing both a polymer or polymer precursor and the pesticidal agent to be encapsulated is extruded as droplets into a solution of crosslinker or hardener. When the droplets hit the crosslinker or hardener, they form stable insoluble gels. The method of extrusion can vary depending on the desired final particle size, which may, for example, be determined by the particular pest for which the pesticide is being designed and the desired method of interaction between the pest and the pesticide. For example if it is intended that the pest ingest the pesticide, the particles should be of a size that is appropriate for ingestion by the pest. For particles ranging in diameter from 20-100 μm, the particles may be extruded via aerosolization and aerosolizing nozzles. In this example, the polymer/pesticidal agent mixture is aerosolized into the crosslinking solution and allowed to gel for an appropriate amount of time. Particles of this size may also be formed via aerosolizing into a batch drying container (spray drying) where the individual particles harden in lieu of crosslinker. For particles ranging in diameter from 100 μm to 1 mm, droplets can be extruded via microchannels positioned on a plate oscillating between 600-2000 Hz, which shears beads of material into carrier liquid containing the crosslinking solution, or from individual extrusion nozzles of varying diameter (0.5 to 10 mm), depending on the desired size.

It will be appreciated that both the type of polymer being used and the solution used to crosslink/harden the polymer can affect the physical characteristics of the particle that is ultimately produced. For example, where an alginate-based polymer is used, gels with a lower alginate (w/v) concentration will be more brittle but will allow for more rapid release, which may be more desirable for non-engineered microbes or fungi where environmental release is not a concern. Gels with a higher alginate (w/v) concentration will be firmer and less expandable and thus will better contain microbes/fungi in the event they are not ingested and remain in the environment. This distinction is even greater for calcium vs. barium crosslinking. Barium crosslinking produces very strong gels that do not degrade in the environment over time, but do not swell very easily when rehydrated, a desired property for genetically engineered encapsulants that risk environmental contamination if not contained securely. Calcium crosslinking produces gels that swell more readily but may degrade in the environment over time. Accordingly, these differences can be exploited to design a particle having the exact specifications desired.

FIG. 3 is a schematic illustration of an exemplary apparatus for making microencapsulated pesticidal agents as described herein. As shown, a first reservoir 30 contains a solution 32 containing the polymer and the desired pesticidal agent. Reservoir 30 is fluidly connected to a mixing chamber 34, which is also connected to air compressor 36. Air flow from air compressor 36 into mixing chamber 34 is controlled via flow valve 38. A nozzle 40 extends from mixing chamber 34. Below nozzle 40 is reservoir 42, which contains a cross-linking or hardening solution 44.

Upon reaching mixing chamber 34, solution 30 is aerosolized upon exposure to air from air compressor 36, producing droplets 46. Droplets 46 are then extruded via nozzle 40 into reservoir 42, where the polymer polymerizes, forming particles 48 comprised of a polymeric coating around the pesticidal agent.

Those of skill in the art may be familiar with other suitable methods for extruding particles and/or particle formation and such methodologies are contemplated by the present disclosure.

As stated above, one suitable polymer for encapsulation of the pesticidal agents described herein is an alginate-based polymer. Alginates are polymer chains of mannuronic (M) and guluronic (G) acid which can be solubilized in water as a monocationic salt. When exposed to various polycationic salts (Ca2+, Ba2+, Zn2+, Ni2+, etc.), these polymers crosslink, forming aggregate hydrogels (26-29). These gels are insoluble in aqueous solution and are stable over a range of pH and in various media. Furthermore, the properties of these gels can be significantly “tuned” based on cation selection, ratio of G:M moieties and pH. (30-33) “Tuning” the alginate polymers results in a variety of stability, decomposition, and release profiles that permit “targeted release” of an encapsulated payload (molecules, bacteria, spores, nanoparticles, etc.).

An exemplary method for producing a bio-pesticidal agent encapsulated in an alginate coating comprises dissolving sodium alginate into sterile water in concentrations ranging from −0.1-5% (w/v). The bio-pesticidal agent is then incorporated into the mixture in a concentration of, for example, I×IO⁹ organisms/mL. Those of skill in the art will recognize that the particular concentration of organisms in the mixture can vary and will be determined by various factors including organism efficacy, longevity, etc. If desired, dyes, stabilizers, or other additives, as described above, could also be included in the mixture. The mixture can then be extruded into a crosslinking solution of 0.05 M calcium chloride or 0.05 M barium chloride, depending on the desired hardness of the gel. In some cases it may be desirable to mix alginate with polylysine (33-10%) to enhance the strength of the gel.

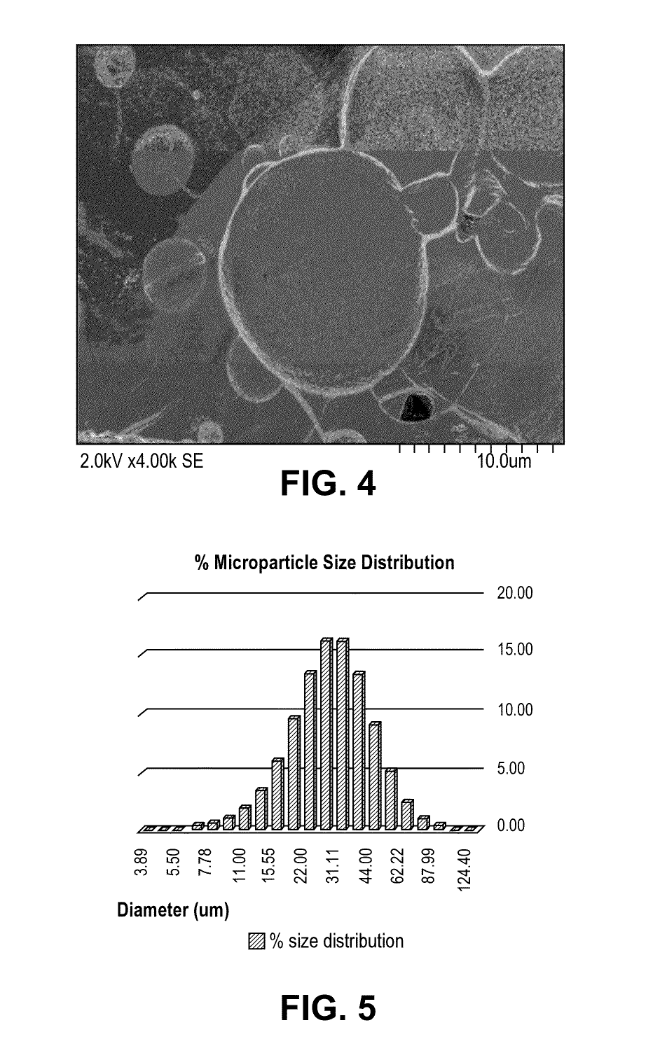

FIG. 4 is a scanning electron micrograph of Pantoea agglomerans encapsulated in an alginate hydrogel using the method described above.

FIG. 5 shows the size distribution of microcapsules produced using the described methodology. These particles sizes are suitable for ingestion by a variety of insects, such as S. gregaria (desert locusts) or Homalodisca vitripennis (glassy-winged sharpshooters). Experiments show that encapsulated P. agglomerans are amenable to suspension in oil or water preparations for Ultra-Low Volume (ULV) spray dispersal, the current methods used to target locus breeding grounds. Furthermore, experiments show that the microencapsulated alginate-carbon matrix permits (1) encapsulation of viable yet metabolically dormant bacterial populations, (2) protection of bacterial from high levels (3000% sterilizing conditions) of UVC radiation, (3) tunable release of payload based on ambient conditions, and (4) protection of encapsulated bacteria from genetic exchange with environmental organisms.

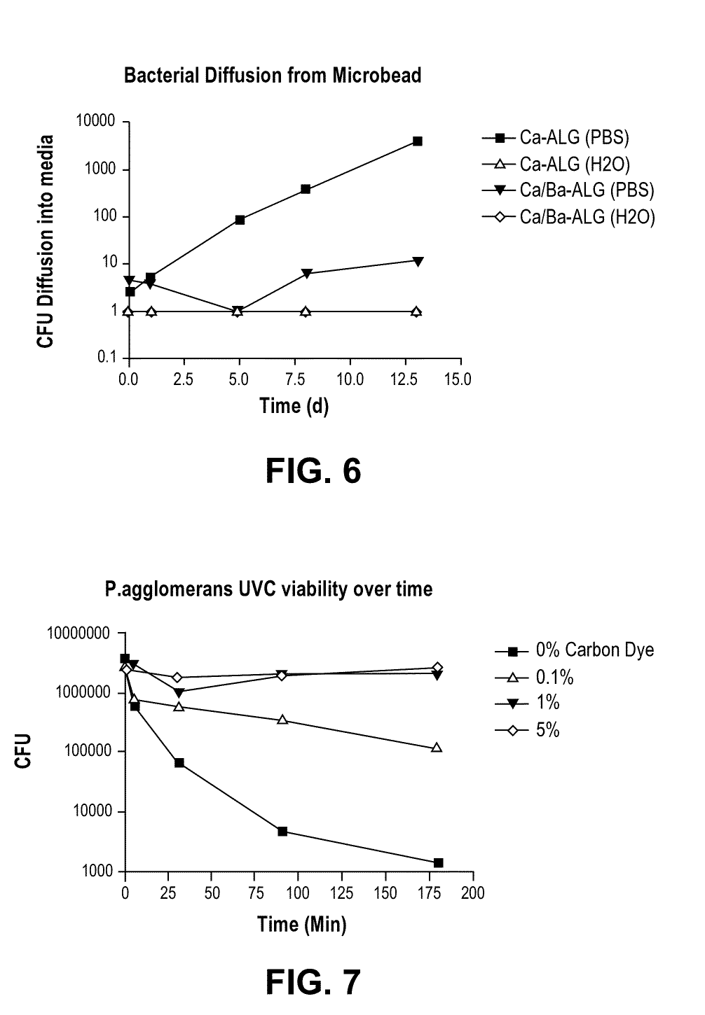

FIG. 6 is a graph showing the P. agglomerans diffusion rate from the microbeads over time.

FIG. 7 shows P. agglomerans survival after UVC treatment.

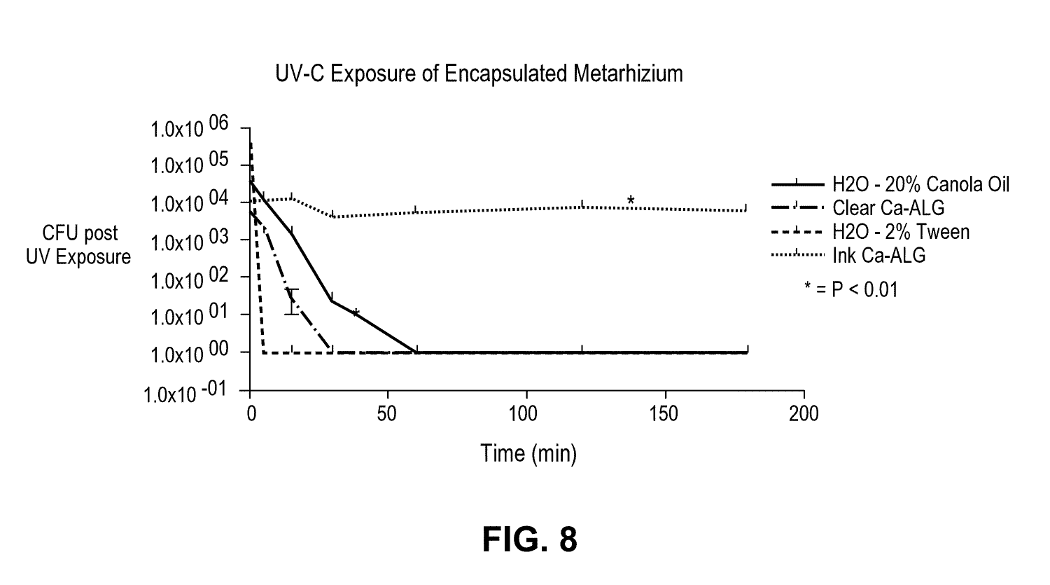

FIG. 8 is a graph showing the effects of UVC exposure of Metarhizium anisopliae (var acrdium) isolate 1014 (M. anisopliae) spores encapsulated in an alginate hydrogel. M. anisopliae spores were grown over 36-48 h in Sauberand (Sb) or potato-dextrose (PD) liquid media containing 0.01-0.05% surfactant (Tween-80, Span-20). The spores were sterile filtered through 50 μm nylon mesh sheets to remove large conidial germinations and were incorporated into solubilized alginates in 2-4% (w/v) concentration. Alginate-spore suspensions were aerosolized into a 0.05 M CaCl₂ solution and allowed to gel for 45 min, washed 3× with sterile H₂O and collected via size filtration on 25 μm nylon mesh sheets.

As stated above, alginate-based polymers are not the only material that can be used to encapsulate pesticidal agents according to the present disclosure. Other materials such as gelatin, methylcellulose, ethylcellulose, whey protein isolates, chitosan/dextran, polymethylmethacrylate, carboxymethylcellulose, and other starch-based polymers could also be used.

Gelatin (cold set gelatin) can be dissolved at concentrations of above 2% and will yield stable gels that will dehydrate fairly slowly. Encapsulation of a pesticidal agent in cold set gelatin in cool water can be performed using the technique described above for encapsulating a bio-pesticidal agent in alginate.

As a further alternative, methylcellulose and ethylcellulose can be derived by acidification of cellulose in methyl/ethylacetic acid or are commercially available. Methylcellulose and ethylcellulose can be hydrated in 1-30% concentrations and sprayed into drying pans, forming microspheres upon contact. The hydrated methylcellulose or ethylcelluose can be combined with organic dyes or other stabilizers/additives prior to spraying.

Chitosan/dextran (−0.1-5% w/v) can be mixed into solution in slightly acidic environments (<pH 5.) The pesticidal agent can then be added and the chitosan will form layers around the pesticidal agent. An organic dye or other additive can then be added (0.1-5% w/v) to coacervate with the chitosan. Dextran sulfate is then added (0.1-5%), which causes a complexation with chitosan to form microspheres.

Polymethylmethacrylate (PMMA) is a synthetic polymer that is produced under relatively benign conditions and thus may be more desirable for encapsulation of fragile or delicate biological species. PMMA is typically dissolved in slightly acidic water to which the pesticidal agent (and any other additives) can be added. The solution is then spray-dried on to collection plates, with the polymer solidifying during the spraying process.

Carboxymethylcellulose (CMC) can be synthesized in a process similar to that described above for methylcellulose. CMC can be combined with K-carrageenan to form hard polymers suitable for harsh conditions or when it is strongly desired that the pesticide not be released into the environment prior to ingestion by the pest.

In embodiments wherein it is not desirable or feasible to include the dye or other additives in the initial coating, secondary, tertiary or even more additional coatings may be applied to the gels/microcapsules to impart additional characteristics or for other purposes. For example, hydrophilic (water miscible) agents could be coated within hydrophobic (oil miscible) coatings and vice versa so as to produce pesticidal agents that are more stable within oil or aqueous environments depending on the intended purpose. In a particular example, alginate hydrogel, may be coated with chitosan.

Application of secondary, tertiary, quaternary coatings can be accomplished via immersion of coated or uncoated microspheres into solutions of the secondary, tertiary coating material (e.g., Chitosan, dextran, PMMA, cellulose, etc.). Coating of the microparticles can occur spontaneously or with agitation and addition of mild heat. The thickness of the coating is directly proportional to the amount of time the microspheres spend immersed in the coating solution. Coatings may also be applied via aerosolization of the coating material onto batches of microparticles that are directly mobilized by mechanical agitation (batch spray coating).

It will be obvious to those of skill in the art that the presently described methods easily lend themselves to producing a variety of different microencapsulated pesticide populations, with each population comprising one or more pesticides within a coating. Furthermore, these coatings, or the particular characteristics which are imparted by these coatings, may or may not be unique to the pesticides contained within.

As discussed above, the present disclosure contemplates the production of pesticide mixtures comprising multiple, perhaps incompatible, pesticides that are protected from each other via their polymeric coatings. Accordingly, the present disclosure also contemplates a method of producing pesticide mixtures comprising producing multiple, distinct populations of microencapsulated pesticides and mixing these distinct populations together. Furthermore, in some embodiments, these pesticide mixtures may contain pesticides that are incompatible but protected from each other via their coatings.

As a still further embodiment, the present disclosure contemplates custom-made pesticides mixtures containing various pesticides that uniquely address the particular pest problems that a particular individual, consumer, region, etc. may need to address. These custom-made pesticide mixtures may include customization of both the pesticide contained within the coating and customization of the coating itself. It will be readily understood that individual populations of microencapsulated pesticides could easily be bulk manufactured and then mixed together, as requested, to produce any particular custom-made pesticide mixture.

As a still further embodiment, the present disclosure provides a method of controlling a pest population comprising exposing the pest population to a pesticide comprising pesticidal agents encapsulated in one or more coatings wherein the coating enhances the pesticidal agents ability to control a pest population.

The specific methods and compositions described herein are representative of preferred embodiments and are exemplary and not intended as limitations on the scope of the invention. Other objects, aspects, and embodiments will occur to those skilled in the art upon consideration of this specification and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which are not specifically disclosed herein as essential. The methods and processes illustratively described herein suitably may be practiced in differing orders of steps, and they are not necessarily restricted to the orders of steps indicated herein or in the claims. As used herein and in the appended claims, the singular forms “a,” “an,” and the include plural reference unless the context clearly dictates otherwise.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications referenced below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

### REFERENCES

1. FAO EPSP (EMPRES) for the CR-(2000) in Report on Desert Locust Econo.

2. Thomson A, Miers H (2002) Assessment of the Socio-Economic Impact of Desert Locusts and Their Control Available at: http://www.ncbi.nlm.nih.gov/pubmed/19003292.

3. Scholler M, Prozell S, Al-Kirshi A-G, Reichmuth C (1997) Towards biological control as a major component of integrated pest management in stored product protection. Journal of Stored Products Research 33:81-97.

4. Grube A (United SEPA, Donaldson D, Kiely T, Wu L (2007) Pesticides Industry Sales and Usage 2006 and 2007 Market Estimates.

5. Davis M, Dinham B (1998) Desert locust control in Africa. Pest Management Notes.

6. Magor J I, Lecoq M, Hunter D M (2008) Preventive control and Desert Locust plagues. Crop Protection 27: 1527-1533.

7. Hedimbi M, Ndeuyeka E, Chinsembu K C (2011) Effects of sunscreens on germination of fungi Metarhizium anisopliae with a view to enhance conidia survival under field conditions. J Microbiology and Antimicrobials 3:248-253.

8. Kaay G P, Hassan S (2000) Entomogenous fungi as promising biopesticides for tick control. Experimental & applied acarology 24:913-26.

9. Kaaya G P, Mwangi E N, Ouna E A (1996) Prospects for Biological Control of Livestock Ticks, Rhipicephalus appendiculatus and Amblyomma variegatum, Using the Entomogenous Fungi Beauveria bassianaand Metarhizium Anisopliae. Journal of Invertebrate Pathology 67:15-20.

10. Samuels R I, Charnley a. K, Reynolds S E (1988) The role of destruxins in the pathogenicity of 3 strains of Metarhizium anisopliae for the tobacco hornworm Manduca sexta. Mycopathologia 104:51-58.

11. Milner R J, Staples J A, Lutton G G (1998) The Selection of an Isolate of the Hyphomycete Fungus, Metarhizium anisopliae, for Control of Termites in Australia. Biological Control 11: 240-247.

12. Kramm K R, West D F (1982) Termite pathogens: Effects of ingested Metarhizium, beauveria, and Gliocladium conidia on worker termites (Reticulitermes sp.). Journal of Invertebrate Pathology 40:7-11.

13. Milner R J, Prior C (1994) Susceptibility of the Australian Plague Locust, Chortoicetes terminifera, and the Wingless Grasshopper, Phaulacridium vittatum, to the Fungi Metarhizium spp. Biological Control 4: 132-137.

14. Blanford S, Thomas M B (2001) Adult survival, maturation, and reproduction of the desert locust Schistocerca gregaria infected with the fungus Metarhizium anisopliae var acridum. Journal of invertebrate pathology 78:1-8.

15. Adetonah S, Coulibaly O, Nouhoheflin T, Kooyman C, Kpindou D (2007) Farmers' Perceptions and Willingness to Pay for Metarhizium-based Biopesticide to Control Cotton Bollworms in Benin (West Africa). 315-319.

16. Amora S S A et al. (2010) The effects of the fungus Metarhizium anisopliae var. acridum on different stages of Lutzomyia longipalpis (Diptera: Psychodidae). Acta tropica 113:214-20.

17. Batta Y (2003) Production and testing of novel formulations of the entomopatho genie fungus Metarhizium anisopliae (Metschinkojf) Sorokin (Deuteromycotina: Hyphomycetes). Crop Protection 22:415-422.

18. Peng G, Wang Z, Yin Y, Zeng D, Xia Y (2008) Field trials of Metarhizium anisopliae var. acridum (Ascomycota: Hypocreales) against oriental migratory locusts, Locusta migratoria manilensis (Meyen) in Northern China. Crop Protection 27: 1244-1250.

19. Scott M, Neeson R, Beckerunderwood H (2011) Spraying locusts with Green Guard ®. 12449: 1-4.

20. Web P (2011) Envera Acquires an EPA Registered Bioinsecticide. PR Web. Available at: http://www.pmeb.com/releases/envera/bioinsecticide/prweb8155499.htm.

21. Hedimbi M et al. (2008) Protection of Metarhizium anisopliae conidiafrom ultra-violet radiation and their pathogenicity to Rhipicephalus evertsi evertsi ticks. Experimental & applied acarology 46: 149-56.

22. Shah P, Aebi M, Tuor U (1998) Method to immobilize the aphid-pathogenic fungus erynia neoaphidis in an alginate matrix for biocontrol. Applied and environmental microbiology 64:4260-3.

23. Fargues J et al. (1996) Variability in susceptibility to simulated sunlight of conidia among isolates of entomopatho genie Hyphomycetes. Mycopathologia 135: 171-181.

24. Brader L, Djibo H, Faye F, Ghaout S (2006) Response to Desert Locusts and their Impacts on Food Security, Livelihoods and Poverty Multilateral Evaluation of the 2003-05 Desert LocustCampaign. Multilateral Evaluation of 2003-05 Desert Lcust Campaign—FAO. Available at: http://scholar.google.com/scholar?hl=en&btnG=Search&q=intitle:Towards+a+More+Effective+Response+to+Desert+Locusts+and+their+Impacts+on+Food+Security,+Livelihoods+and +Poverty+Multilateral+Evaluation+of+the+2003?05+Desert+Locust+Campaign#0 [Accessed Aug. 7, 2012].

25. Alves R T, Bateman R P, Prior C, Leather SR (1998) Effects of simulated solar radiation on conidial germination of Metarhizium anisopliae in different formulations. Crop Protection 17:675-679.

26. Bashan Y (1986) Alginate Beads as Synthetic Inoculant Carriers for Slow Release of Bacteria That Affect Plant Growth. Applied and environmental microbiology 51: 1089-1098.

27. Bashan Y, Hernandez J-P, Leyva L, Bacilio M (2002) Alginate microbeads as inoculant carriers for plant growth-promoting bacteria. Biology and Fertility of Soils 35:359-368.

28. Ribeiro A J, Neufeld R J, Arnaud P, Chaumeil J C (1999) Microencapsulation of lipophilic drugs in chitosan-coated alginate microspheres. International journal of pharmaceutics 187: 115-23.

29. Barrias C C, Ribeiro C C, Rodrigues D, Sa Miranda M C, Barbosa M a. (2005) Effect of Calcium Phosphate Addition to Alginate Microspheres: Modulation of Enzyme Release Kinetics and Improvement of Cell Adhesion. Key Engineering Materials 284-286:689-692.

30. Liu X et al. (2004) Swelling behaviour of alginate-chitosan microcapsules prepared by external gelation or internal gelation technology. Carbohydrate Polymers 56:459-464.

31. Liu F, Urban M W (2010) Recent advances and challenges in designing stimuli-responsive polymers. Progress in Polymer Science 35:3-23.

32. Abreu F, Bianchini C, Forte M, Kist T (2008) Influence of the composition and preparation method on the morphology and swelling behavior of alginate-chitosan hydrogels. Carbohydrate Polymers 74:283-289.

33. Sugiura S, Oda T, Izumida Y, Aoyagi Y (2005) Size control of calcium alginate beads containing living cells using micro-nozzle array. Microscope 26:3327-3331.

34. Fravel D R, Marois J J, Lumsde R D, Connick W J (1985) Encapsulation of Potential Biocontrol Agents in an Alginate-Clay Matrix. Phytopathology 75:774-778.

35. Chen Y, Mohanraj V J, Wang F, Benson H a E (2007) Designing chitosan-dextran sulfate nanoparticles using charge ratios. AAPS PharmSciTech 8:E98.

36. Chen H et al. (2007) Preparation and characterization of novel polymeric microcapsules for live cell encapsulation and therapy. Cell biochemistry and biophysics 47: 159-68.

37. Li X et al. (2008) Preparation of alginate coated chitosan microparticles for vaccine delivery.BMC biotechnology 8:89.

38. Sheu T Y, Marshall R T, Heymann H (1993) Improving survival of culture bacteria in frozen desserts by microentrapment. Journal of dairy science 76: 1902-7.

39. Krasaekoopt W (2003) Evaluation of encapsulation techniques of probiotics for yoghurt. International Dairy Journal 13:3-13.

40. Krasaekoopt W, Bhandari B, Deeth H (2006) Survival of probiotics encapsulated in chitosancoated alginate beads in yoghurt from UHT- and conventionally treated milk during storage. LWT-Food Science and Technology 39: 177-183.

41. Zohar-Perez C, Chernin L, Chet I, Nussinovitch A (2003) Structure of dried cellular alginate matrix containing fillers provides extra protection for microorganisms against UVC radiation. Radiation research 160: 198-204.

42. Sword G A (2003) To be or not to be a locust? A comparative analysis of behavioral phase change in nymphs of Schistocerca americana and S. gregaria. Journal of Insect Physiology 49:709-717.

43. Sieglaff D H, Pereira R M (1998) Microbial Control of Schistocerca americana (Orthoptera!: Acrididae) by Metarhizium flavoviride (Deuteromycotina): Instar Dependent Mortality and Efficacy of Ultra Low Volume Application Under Greenhouse Conditions.

44. Sieglaff D H (1997) Pathogenicity of Beauveria bassiana and Metarhizium flavoviride (Deuteromycotina) to Schistocerca americana.

45. E.P.A. US (2011) Pesticide Registration Manual: Chapter 12—Applying for an Experimental Use Permit: Subpart A—Federal Issuance of Experimental Use Permits Available at: http://www.epa.gov/pesticides/bluebook/chapterl 2.html.

46. Lichtenberg E (1987) Integrated versus chemical pest management: The case of rice field mosquito control. Journal of Environmental Economics and Management 14:304-312.

47. Way M., van Emden H. (2000) Integrated pest management in practice—pathways towards successful application. Crop Protection 19:81-103.

48. Zimmermann G (1982) Effect of high temperatures and artificial sunlight on the viability of conidia of Metarhizium anisopliae. Journal of Invertebrate Pathology 40:36-40.

49. MOORE D, BRIDGE P D, HIGGINS P M, BATEMAN R P, PRIOR C (1993) Ultra-violet radiation damage to Metarhizium flavoviride conidia and the protection given by vegetable and mineral oils and chemical sunscreens. Annals of Applied Biology 122:605-616.

50. Braga G U, Flint S D, Miller C D, Anderson a J, Roberts D W (2001) Variability in response to UVB among species and strains of Metarhizium isolated from sites at latitudes from 61 degrees N to 54 degrees S. Journal of invertebrate pathology 78:98-108.

51. Khachatourians G G (1986) Production and use of biological pest control agents. Trends in Biotechnology 4: 120-124.

52. Champagne C P, Gaudy C, Poncelet D, Neufeld R J (1992) Lactococcus lactis release from calcium alginate beads. Applied and environmental microbiology 58: 1429-34.

53. Zhu J-H et al. (2005) Encapsulating live cells with water-soluble chitosan in physiological conditions. Journal of biotechnology 117:355-65.

What is claimed is:

1. A microparticle comprising:
a pesticidal agent encapsulated within a polymer coating, the polymer coating comprising an oil-soluble dye wherein the oil-soluble dye and the polymer coating increases the pesticidal agents ability to withstand UV radiation.

2. The microparticle of claim 1 wherein the oil-soluble dye is within a matrix of the polymer coating.

3. The microparticle of claim 1 wherein the pesticidal agent is a bio-pesticide.

4. The microparticle of claim 1 wherein the polymer coating encapsulates more than one type of pesticidal agent.

5. The microparticle of claim 1 further comprising a secondary coating configured to further enhance the pesticidal agents ability to control a pest population.

6. The microparticle of claim 1 wherein the polymer coating is formed from a polymer selected from the group consisting of alginate, gelatin, methylcellulose, ethylcellulose, chiton/dextran, Whey protein and polymethylmethacrylate.

7. The microparticle of claim 1 wherein the oil-soluble dye is India ink.

8. The microparticle of claim 1 wherein the polymer coating is degraded by the environmental conditions encountered within the pest's digestion tract.

9. The microparticle of claim 1 wherein the polymer coating is formed from alginate.

10. The microparticle of claim 2 wherein the matrix of the polymer coating is an ionically cross-linked alginate hydrogel coating and the oil-soluble dye is selected from the group consisting of india ink, metal oxide, and carbonaceous micro/nanoparticles.

11. The microparticle of claim 9 wherein the alginate of the polymer coating is a crosslinked hydrogel.

12. The microparticle of claim 11 wherein the alginate crosslinked hydrogel is coated with chitosan.

13. The microparticle of claim 1 wherein the oil-soluble dye is selected from the group consisting of:
iron oxide, carbon, logwood, cinnabar, Cadmium Red, Napthol pigments, disazodiarylide, disazopyrazolone, Cadmium Yellow, curcumine, Chrome Yellow, chromium oxide, malachite, ferrocyanides, ochre, umber, Sweedish Red, lead chromate, Azure Blue, Cobalt Blue, Prussian Blue, Manganese Violet, quinacridone, lead carbonate, titanium dioxide, barium sulfate, zinc oxide, Carbon Black, Ivory Black, Vine Black, Lamp Black, and Titanium Black.

14. A method of controlling a pest population comprising:
exposing a pest population to a particle-based pesticide, wherein the particle-based pesticide comprises a plurality of microparticles wherein a mircroparticle of the plurality of microparticles comprises a pesticidal agent encapsulated within a polymer coating, the polymer coating comprising an oil-soluble dye wherein the oil-soluble dye and the polymer coating increases the pesticidal agents ability to withstand UV radiation.

15. A method of manufacturing a pesticide comprising:
encapsulating a pesticidal agent within a polymer coating configured with an oil-soluble dye to enhance the pesticidal agent s ability to control a pest population.

16. The method of claim 15 wherein the step of encapsulating comprises extruding droplets comprising the pesticidal agent, oil-soluble dye and a polymer into a cross-linking or hardening solution to form particles.

17. The method of claim 16 further comprising surrounding the polymer coating of the particles with a secondary coating configured to further enhance the pesticidal agents ability to control the pest population.

18. The method of claim 16 wherein the polymer comprises an alginate.

19. The method of claim 15 further comprising selecting the pesticidal agent based on a specific pest population against which the pesticide is to be used.

20. The method of claim 15 further comprising selecting the materials to use to form the polymer coating based on a specific pest population against which the pesticide is to be used.
